(19) United States
(12) Patent Application Publication
(10) Pub. No.: US 2026/0124996 A1
(43) Pub. Date: May 7, 2026

(54) STORAGE BAG

(71) Applicant: Outlier Campers LLC, Cambridge, MA (US)

(72) Inventor: Ananda Wickramasekera, Cambridge, MA (US)

(21) Appl. No.: 19/173,341

(22) Filed: Apr. 8, 2025

Related U.S. Application Data
(60) Provisional application No. 63/715,752, filed on Nov. 4, 2024.

(51) Int. Cl. B60R 9/06; A45C 5/02; A45C 13/00; A45C 13/02; A45C 13/10; A45C 13/30

(52) U.S. Cl. CPC B60R 9/065; A45C 5/02; A45C 13/008; A45C 13/30; A45C 2013/026; A45C 2013/1015

(57) ABSTRACT

A storage bag is configured to be mountable on the exterior of a vehicle (e.g., pickup truck tailgate, rear-mounted vertical spare tire, vehicle rack, or a MOLLE attachment on a vehicle). The bag may be detachably connected via at least one strap, fastener, or by use of MOLLE webbing. The bag may feature a lid opening on the rear and sides, partially surrounding the front, that opens from the vehicle-facing side toward the opposite side (e.g., a lid that opens from the rear of the bag toward the front), with the lid designed to fold vertically or nearly vertically when opened. The bag retains its shape, including when empty (i.e., it is semi-rigid), may contain an internal rigid container or pocket, and may be constructed with a waterproof or water-resistant exterior material.

### CROSS-REFERENCE TO RELATED APPLICATIONS

This application claims under 35 U.S.C. § 119(e) the benefit of U.S. Provisional Patent Application No. 63/715,752 filed Nov. 4, 2024, and titled “Storage Bag,” the disclosure of which is hereby incorporated herein by reference in its entirety.

### TECHNICAL FIELD

The present disclosure relates to storage bags specifically designed for attachment to vehicles or vehicle components, featuring a semi-rigid or molded structure that maintains shape while securely holding objects. These storage bags incorporate waterproof materials and can accommodate rigid inserts for additional stability. They include a lid with a vehicle-facing side and an opposite side, designed to open from an elevated position on the vehicle-facing side, enabling the lid to fold back and remain open without external support, thus allowing convenient access. The disclosure further includes specialized attachment features such as MOLLE webbing, loops, and straps with hook-and-loop fasteners, allowing secure attachment to various vehicle accessories. This design enables practical use and stability in mobile environments, with versatile access configurations that enhance functionality depending on placement within the vehicle.

### BACKGROUND

Existing pickup tailgate-mounted or vehicle spare tire-mounted storage or trash bags attach to a tailgate or vertically mounted spare tire with straps that go around and/or through the tailgate or spare tire, respectively. They do not contain MOLLE webbing that can be used to create a secure fit between the bag and a compatible MOLLE rack, MOLLE panel, or other MOLLE attachment attached to a vehicle, which can be achieved by interweaving one or more straps through the MOLLE rack, panel, or attachment spacing and/or webbing and the bag webbing.

Existing storage bags also open from the front of the bag toward rear of the bag, or the vehicle-facing side, requiring the lid to be supported in an open position when attached to a vehicle (e.g., the lid may need to be tucked behind the bag and the tailgate or spare tire, respectively, or lifted over the tailgate or spare tire, respectively, but that isn't always possible) so that a person may access the inside of the bag with both hands to put items in or take items out or a person would have to hold the lid open with one hand or otherwise support the lid. Tucking the lid between the bag and vehicle may also cause damage to delicate, painted vehicle surfaces, particularly if any hard portions of the lid fasteners, such as buckles or zippers, contact the vehicle surface. Existing storage bags are also primarily made of soft fabric, which may sometimes require the sides of the bag to be pulled open or pulled apart to more easily load, unload, or search for items (e.g., collapsed, soft-sided walls may have to be moved out of the way to access the inside of the bag).

It would be beneficial for a storage bag to: be attachable directly to a vehicle tailgate or horizontal spare tire, to a MOLLE rack or attachment, or to another type of rack, attachment, surface, or vehicle body part; be openable and accessible without the need to support the lid in open position; retain its shape to make it easier to load/unload items; be capable of accepting a removable, rigid liner or container; contain an internal pocket, and be waterproof or water-resistant when closed.

The storage bag disclosure described herein may be detachably connected directly to a pickup truck tailgate or vertically mounted rear spare tire; to a vehicle rack, accessory, or other body part; or to a MOLLE rack, MOLLE panel, or other MOLLE attachment on a vehicle. By containing MOLLE webbing, at least one strap, and/or at least one fastener, the storage bag is directly attachable to a vehicle, anywhere a strap and/or fastener may be attachable to, through, or around an object; or it may be attachable to a MOLLE-compatible accessory by at least one strap interwoven between the bag's MOLLE webbing and the MOLLE accessory's spacing or webbing, as the MOLLE system or standard is designed for.

The lid of the storage bag may be fully openable from the rear (e.g., vehicle-facing side) and joined in the front (e.g., like a hinge on the side facing away from the vehicle) to the body of the bag so that it may fold forward and, because there may be nothing to obstruct the lid in front of the bag when it is opened, the lid may be kept in open position without support either by hand or by being tucked behind or otherwise supported by another object. By having a lid opening that is on the rear of the bag (e.g., the vehicle-facing side), the sides of the bag, and also partially surrounds the front of the bag (e.g., side opposite of the vehicle), the lid may more easily drop down, when opened, so that it may be substantially vertical, so as not to become an obstruction to someone accessing the bag from the front (e.g., if the lid opening is only on the rear and sides of the bag, the lid, particularly if it's not made of a soft, highly flexible fabric material, may stick straight out in front of the bag, horizontally, when opened, potentially becoming an obstruction to a person accessing the bag from the front).

By having the lid opening portion at the rear of the bag (e.g., on the side facing the vehicle) higher than the non-opening or partially opening portion at the front of the bag (e.g., opposite side of the vehicle), where the lid remains attached to the body of the bag (e.g., like a hinge), accessing the bag from the front may be made easier because the front of the bag may be lower than the rear of the bag which is particularly important if the bag is positioned at an elevated height, particularly if mounted on a spare tire or tailgate of a tall vehicle. The higher lid opening at the rear of the bag than at the front of the bag along with the lid opening from the rear of the bag toward the front of the bag will also be beneficial in keeping the lid in an open position because it will tend to more easily fall into an open position than a closed position (e.g., existing storage bags that may be higher at the back than at the front but have an lid opening in the front of the bag may have a lid that will tend to fall closed when not supported).

With a rear opening lid that, when opened, may be folded substantially vertical, in front of the bag, an internal pocket on the interior side of the lid would provide useful, easily accessible, secondary storage for small items. The storage bag also retains its shape, even when empty, making loading and unloading items easier because the semi-rigid construction may prevent the bag's walls from collapsing inward onto itself and/or onto items or before items may be loaded. Because the storage bag has a semi-rigid structure, it can more easily accommodate a rigid storage container inside the body of the bag, which may help contain leaks (e.g., from trash), protect the bag from sharp objects, protect fragile objects from impacts to the exterior of the bag, and may make loading or unloading items easier because the entire container with contents may be inserted or removed, respectively. And the storage bag may be constructed of waterproof or water-resistant exterior fabric material, which would make it suitable for mounting on the exterior of a vehicle.

### SUMMARY OF THE DISCLOSURE

The storage bag described herein contains MOLLE webbing, straps, and/or fasteners which may allow it to be directly mountable to a vehicle tailgate or vertically mounted spare tire; mountable to a vehicle roof rack, other rack, or other body part or accessory; or mountable to a MOLLE-type rack or other MOLLE attachment which may fixed anywhere on a vehicle, camper, or trailer (e.g., on pickup truck tailgate or inside its bed; on a vehicle spare tire; or on a vehicle's, trailer's, or camper's roof, rear, side, or other surface).

The storage bag described herein may also have a lid-opening section at the rear of the bag (e.g., the vehicle-facing side) that also partially surrounds the front of the bag (e.g., the opposite side of the vehicle-facing side) that will allow the lid to open from the rear of the bag toward the front of the bag (e.g., from the vehicle-facing side of the bag toward the opposite side) and fold so that it is substantially vertical; and the lid opening may be higher at the rear of the bag (e.g., vehicle-facing side) than it is on the front of the bag (e.g., the side opposite of the vehicle-facing side), such that the lid opening slopes downward, from the rear to the front. This lid configuration may allow the lid to more easily fall or fold forward (e.g., open from the rear to the front of the bag or from the vehicle-facing side to the opposite side) when opening the bag, without the need for the lid to be supported in an open position and may also allow for easier access to the body of the bag to place items inside, remove items, or search for items inside the bag.

The storage bag described herein may also retain its shape (i.e., be semi-rigid), including when empty, by being constructed of or contain, molded ethyl vinyl acetate (EVA) foam, other moldable foam, an internal frame, or rigid or semi-rigid inserts. This may make it easier to store items, remove items, or move items inside the bag without the walls of the bag collapsing. It may also contain an internal, removable container or rigid liner, such as a rigid trash can, which may help contain liquids (e.g., from trash), help protect the bag from sharp objects, or make loading or unloading items easier by inserting or removing, respectively, the entire container loaded with contents. The semi-rigid storage bag construction may also make it easier to use a disposable trash bag inside, with or without the rigid, internal container. The vehicle storage bag may further be constructed of a waterproof or water-resistant exterior fabric material, such as nylon, vinyl, canvas, Dyneema, other composite fabric, or other suitable fabric or material that is soft-to-the-touch, which, if it comes in contacted with delicate painted vehicle surfaces or other objects, may not cause damage to those surfaces or objects.

In some embodiments, a storage bag comprises a storage body configured to hold an object and a lid that opens and closes to provide access to the storage body. The lid includes a vehicle-facing side and an opposite side, with an opening section on the vehicle-facing side to allow the lid to open. The storage bag is designed to be removably attached to a vehicle or a vehicle component/accessory and is constructed from a material that retains its shape. The storage bag may be made of a semi-rigid material, and in some variations, it may be waterproof. Additionally, the storage bag may consist of molded ethyl vinyl acetate (EVA) foam. The storage body may be configured to receive a rigid insert or container for added stability. The storage bag may further include MOLLE webbing or a loop, allowing attachment to a vehicle or a vehicle component/accessory. A strap with a fastener, such as a hook-and-loop fastener, may also be used to secure it to a vehicle or accessory. The lid may be configured to fold from the vehicle-facing side toward the opposite side, enabling it to remain open without external support. In some versions, the lid opening section on the opposite side may partially surround that side, and the opening section on the vehicle-facing side may be positioned higher than on the opposite side.

In some embodiments, the storage bag has a lid with a vehicle-facing side and an opposite side, and an opening section that at least partially surrounds the opposite side and the vehicle-facing side, allowing the lid to open from one side toward the other. The opening side may be positioned higher than the other, so that the bag remains open without external support. In this form, the storage bag may be semi-rigid, waterproof, and made from molded ethyl vinyl acetate (EVA) foam. It may be configured to receive a rigid insert or container, and may include MOLLE webbing, a loop, a strap with a fastener, or a combination of these attachment features.

In some embodiments, the storage bag has a lid opening section on the vehicle-facing side that is positioned higher than the opening section on the opposite side, allowing the lid to open from the vehicle-facing side toward the opposite side. The opening section on the opposite side may partially surround that side. Both the vehicle-facing and opposite-side lid sections may be equipped with a closure mechanism to open and close the bag. This version of the storage bag is formed from a semi-rigid material and may also be waterproof, made from molded ethyl vinyl acetate (EVA) foam, and designed to receive a rigid insert or container. Additionally, the bag may include MOLLE webbing, a loop, a strap with a fastener, or a combination of these attachment options to secure it to a vehicle or accessory.

### BRIEF DESCRIPTION OF DRAWINGS

FIG. 1 shows a front perspective view of an exemplary storage bag in a closed configuration, according to some embodiments of the present disclosure;

FIG. 2 shows a rear perspective view of an exemplary storage bag in a closed configuration, according to some embodiments of the present disclosure;

FIG. 3 shows a front perspective view of an exemplary storage bag with its lid in transition of being opened or closed and a container stored inside the body of the bag, according to some embodiments of the present disclosure;

FIG. 4 shows a front perspective view of an exemplary storage bag with its lid in an open configuration and a container in transition of being inserted or removed from the bag, according to some embodiments of the present disclosure;

FIG. 5 shows a front perspective view of an exemplary storage bag detachably connected to an exemplary pickup truck's tailgate, according to some embodiments of the present disclosure;

FIG. 6 shows a front perspective view of an exemplary storage bag with its lid in an open configuration and a container in transition of being inserted or removed from the bag while it is detachably connected to an exemplary pickup truck's tailgate, according to some embodiments of the present disclosure;

FIG. 7 shows a front perspective view of an exemplary storage bag detachably connected to an exemplary vehicle's spare tire, according to some embodiments of the present disclosure; and

FIG. 8 shows a front perspective view of an exemplary storage bag with its lid in an open configuration and a container in transition of being inserted or removed from the bag while it is detachably connected to an exemplary vehicle's spare tire, according to some embodiments of the present disclosure.

While the disclosure is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION OF SPECIFIC EMBODIMENTS

Described herein are devices, components, assemblies, systems, methods, etc. for storage bags. The description and accompanying figures, which describe and show certain embodiments, are made to demonstrate, in a non-limiting manner, several possible configurations of storage bags, apparatuses, components, assemblies, systems, etc. and various methods of using them according to various aspects and features of the present disclosure. Accordingly, the disclosure is not limited to the specific embodiments described. Rather, the inventive principles associated with the embodiments described herein, including with respect to the apparatuses, devices, components, assemblies, systems, methods, etc. described herein, may be applied in a variety of ways, including to other types of apparatuses, devices, components, assemblies, systems, methods, etc. General and specific apparatuses, devices, components, assemblies, systems, methods, etc. are described herein sufficiently to enable one to develop a variety of implementations/applications without undue experimentation. In the development of particular applications, numerous implementation-specific decisions will be made to achieve the design-specific goals, which will vary from one implementation/application to another. It will be appreciated that, having access to this disclosure and reading this disclosure, such a development effort would be a routine undertaking for persons of ordinary skill in the art.

This disclosure does not intend to distinguish between components that differ in name but not function. In the following discussion and in the claims, the terms “including.” “includes,” “comprising.” “have,” and “has” are used in an open-ended fashion, and thus should be interpreted to mean “including, but not limited to.” The word “or” is used in the inclusive sense (i.e., “and/or”) unless a specific use to the contrary is explicitly stated.

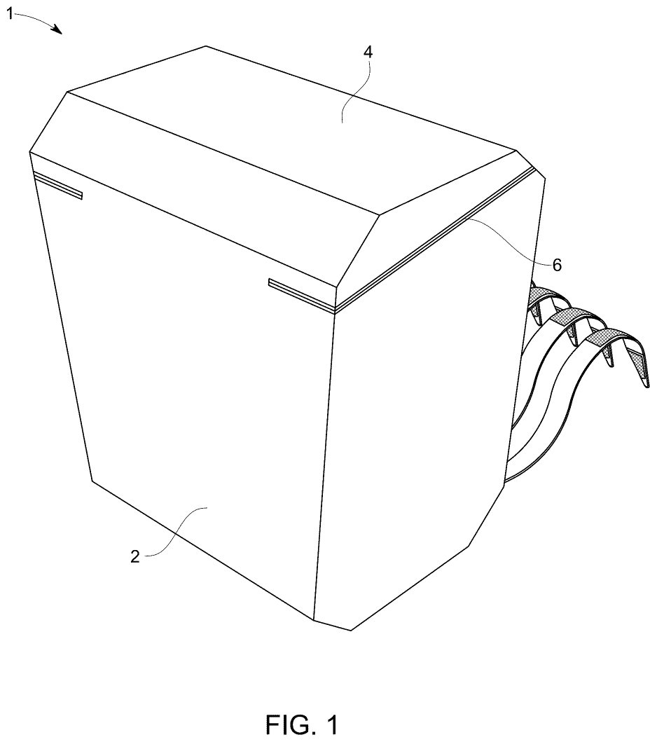

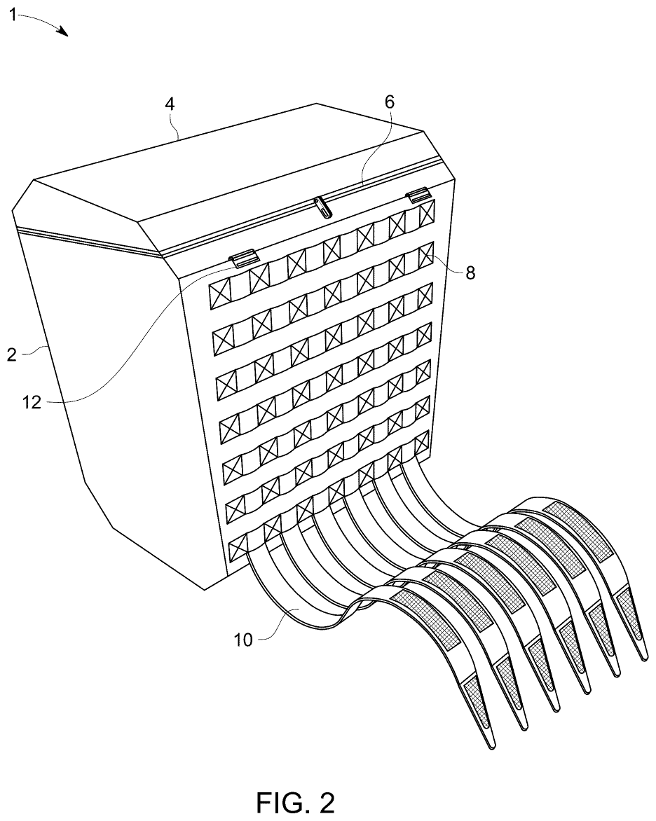

Exemplary storage bag 1, as shown in FIGS. 1 and 2 and described herein, is a semi-rigid vehicle exterior storage bag, capable of being detachably connected to a vehicle or to a MOLLE-compatible accessory on a vehicle, camper, trailer, or other object. It has a lid opening that may allow the lid to open from the rear of the bag forward and fold vertically or almost vertically at the front of the bag. It may be made of or contain molded ethyl vinyl acetate (EVA) foam or other moldable foam, or have an internal, rigid or semi-rigid frame or inserts to give the bag structure or allow it to retain its shape, even when empty. A soft-touch exterior material of the storage bag may be waterproof or water-resistant (e.g., preventing water penetration under normal or specified use conditions) and/or non-marking on delicate surfaces.

As shown in FIGS. 1 and 2, storage bag 1 may contain body 2, which may be a storage body of the bag that may contain items stored inside; lid 4, which may be a lid to close the bag; and opening 6, which may be a lid opening mechanism to allow lid 4 to be opened so that body 2 may be accessed to place items inside or remove items from storage bag 1 or allow storage bag 1 to be closed. As shown in FIG. 2, storage 1 bag may also contain webbing 8, which may be MOLLE webbing that may conform to the MOLLE standard and/or be compatible with MOLLE-type webbing and/or spacing on corresponding racks, panels, or accessories.

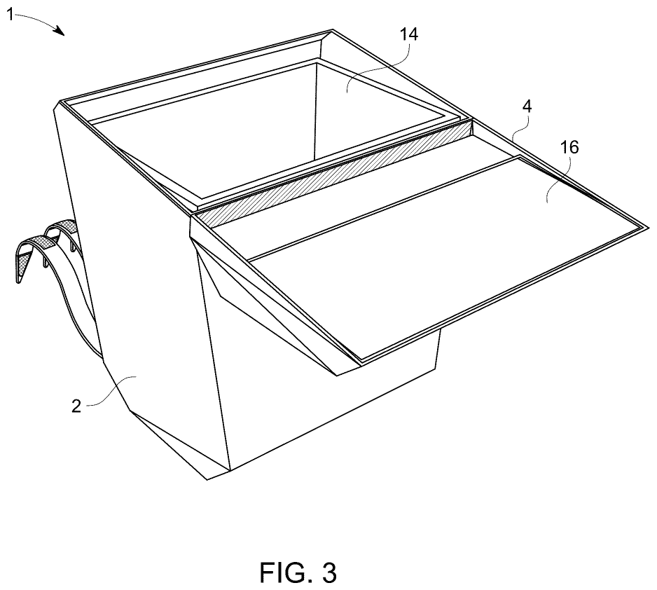

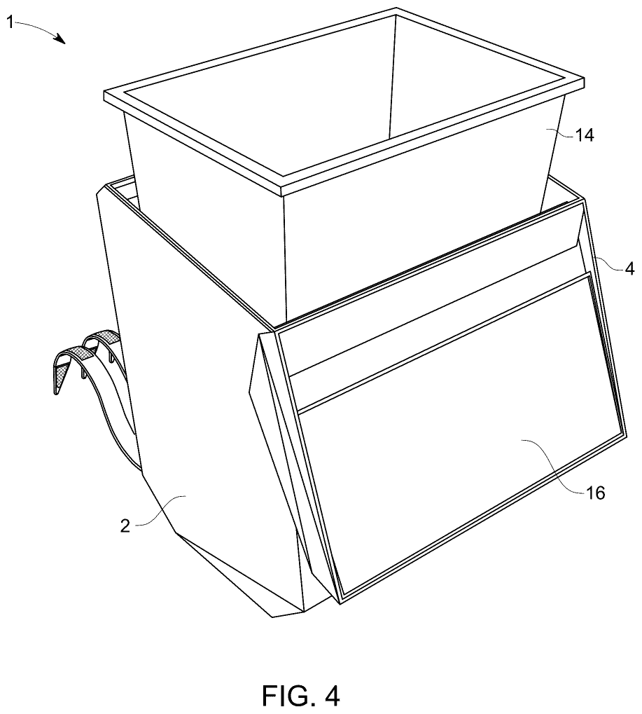

As also shown in FIG. 2, storage bag 1 may contain one or more of strap 10, which may be a strap to secure storage bag 1 by connecting webbing 8 to compatible webbing or spacing on a MOLLE accessory or to, around, or through any object a strap may be connected to, around, or through. Fastener 12, as shown in FIG. 2, may further aid in securing storage bag 1 to an object, if needed, or may provide an alternate connection method. Storage bag 1 may have, inside body 2, container 14, which may be a removable rigid liner or container, as shown in FIGS. 3 and 4. As also shown in FIGS. 3 and 4, lid 4 may contain pocket 16, which may be a pouch or pocket that is open on one end or openable by a zipper or other fastener for storage of small items (e.g., extra, disposable trash bags, rags or towel, tools, zip tics, etc.).

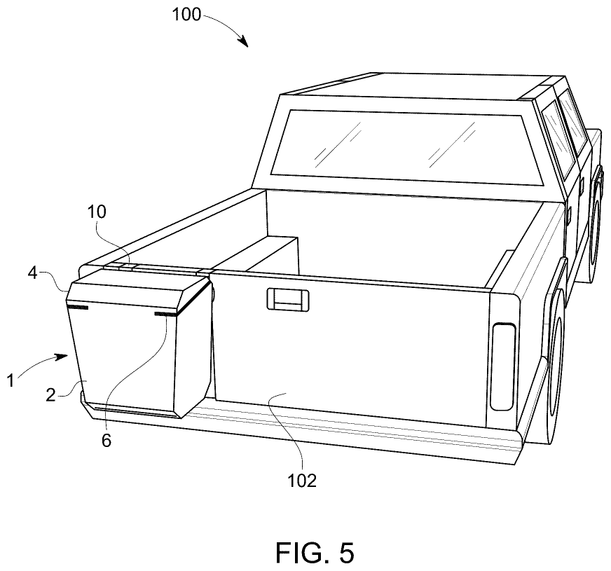

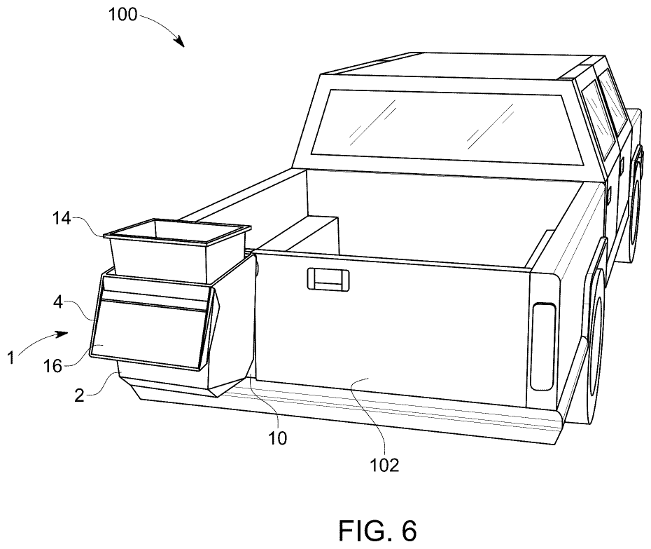

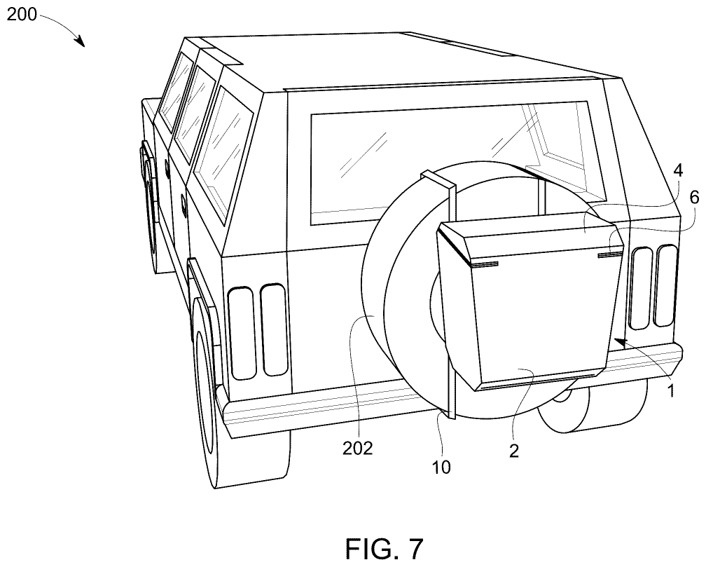

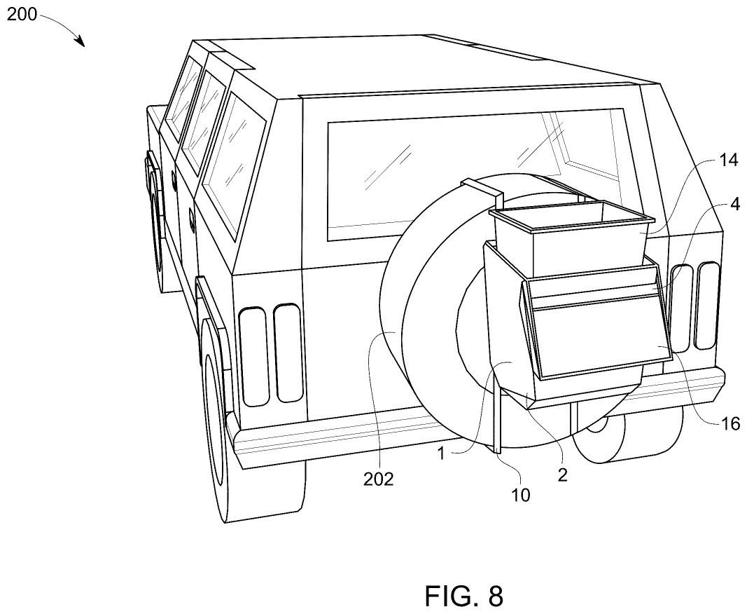

Storage bag 1, may be detachably connected directly to a pickup truck tailgate, as shown in FIGS. 5 and 6 or to a vertically mounted rear spare tire, as shown FIGS. 7 and 8, to a vehicle rack, accessory, or other body part; or to a MOLLE rack, MOLLE panel, or other MOLLE attachment on a vehicle. As previously shown in FIG. 2, MOLLE webbing 8 and/or at least one of strap 10 and, optionally, fastener 12, may allow storage bag 1 to be directly and detachably connected to a vehicle anywhere a loop, strap, and/or fastener may be attachable and/or fastened to through or around; or using MOLLE webbing 8 and one or more of strap 10, and optionally fastener 12, storage bag 1 may be attachable to MOLLE-compatible accessories by at least one of strap 10 being interwoven between and through webbing 8 and compatible or corresponding MOLLE webbing or spacing on a MOLLE-type rack, panel, or other accessory, as the MOLLE system or standard is designed for. As shown in FIG. 2, strap 10 may also contain components of a fastener or fastening system, such as a hook and loop fastener, so that it may be passed through webbing 8 and compatible webbing or spacing on a MOLLE-type accessory or secured to, through, or around any fixed object on a vehicle then fastened back onto itself to create a closed, secure attachment. As also shown in FIG. 2, the tip of strap 10 may be slightly pointed or narrow and slightly rigid to allow strap 10 to be more easily woven through webbing 8 and the webbing and/or spacing on a MOLLE-type object, then tucked tightly back into webbing 8 or fastened back onto any portion of a fastening mechanism that may exist on strap 10 (e.g., such as hook and loop fasteners) to create a tight, closed, and secure fit, as MOLLE webbing is designed for.

Alternatively, strap 10 may be fastened to through or around an object then fastened to or through fastener 12, which may be a slide buckle, clip, or closed or partially closed loop. Webbing 8, strap 10, and fastener 12 may be primarily or partially composed of nylon or similar strapping material. Strap 10 may further contain a rigid or semi-rigid tip made of plastic, metal, or similar material, and may also contain hook and loop fasteners. Fastener 12 may further contain a buckle, such as a slide buckle or clip made of plastic or metal and/or a loop made of plastic, metal, or fabric that may allow one of strap 10 to be passed through it or fastened to it.

Any of carabiners, clips, zip ties, cords, bungee cords, cables, padlocks, or any fastening mechanism that can be passed through or fastened around webbing 8 and/or fastener 12 and passed through or around holes, spacing, or webbing on another object or fastened in any way to another object can also be used to secure, lock, or fasten storage bag 1 to that object which may be on a vehicle, camper, trailer, or other object. FIGS. 5 and 6 show storage bag 1 secured to tailgate 102 of exemplary truck 100, with straps 10 passed over the tailgate and through the gap at the bottom of the tailgate. FIGS. 7 and 8 show storage bag 1 secured to spare tire 202 of exemplary vehicle 200, with straps 10 passed around and/or through spare tire 202.

Body 2 and lid 4 of storage bag 1 may each be constructed of or contain a semi-rigid material such has as: molded ethyl vinyl acetate (EVA) foam or other types of molded foam; an internal, rigid or semi-rigid frame made of plastic, metal, or other material; and/or rigid or semi-rigid inserts made of plastic, metal, cardboard, foam, or other material that may allow storage bag 1 to retain its shape, including when empty, as shown in FIGS. 1 and 2. Body 2 and lid 4 may each contain waterproof or water-resistant material such as vinyl, canvas, or other suitable material on their outer surfaces to make storage bag 1 suitable for detachable mounting on the exterior of a vehicle. A flap or portion of lid 4 may overlap a portion of body 2, where an opening between them may exist, to protect the opening or joint between body 2 and lid 4 from water (e.g., rainwater). Alternatively, opening 6, as shown in FIGS. 1 and 2, may itself be waterproof or water-resistant (e.g., a waterproof zipper) such that no overlap between lid 4 and body 2 may be needed.

Opening 6 between body 2 and lid 4 may contain a zipper and zipper pulls, as shown in FIGS. 1 and 2, and/or another lid opening mechanism such as hook and loop fasteners, straps and buckles, snaps, magnets, other opening and closing mechanisms, or a combination of opening and closing mechanisms, where a portion of opening 6 may be present on body 2 and a portion may be present on lid 4, which may allow body 2 to be fastened to lid 4 to securely close storage bag 1 or opened to allow body 2 to partially separate from lid 4 to access the inside of storage bag 1. Opening 6 may be present on the rear, sides, and partially surrounding the front of storage bag 1, as shown in FIGS. 1 and 2.

This configuration may allow storage bag 1 to be opened from the rear of the bag toward the front of the bag, as shown in transition in FIG. 3, and may also allow lid 4 to drop or fold vertically or almost vertically, when opened, as shown in FIG. 4 (e.g., if opening 6 was only present on the rear and sides of storage bag 1 or was only opened in the portions on the rear and sides, lid 4, particularly if it is semi-rigid, may have the tendency to stick out horizontally or more horizontally from storage bag 1, as shown in FIG. 3, which may cause an obstruction to accessing body 2 from the front, however, by having opening 6 also partially surround the front of storage bag 1, as shown in FIG. 1, and by opening 6 along the rear, sides, and the portion that partially surrounds the front of storage bag 1, lid 4 may more easily fold downward or vertically, as shown in FIG. 4, making access to body 2 easier).

Opening 6 may also be higher at the rear of storage bag 1 than at the front of storage bag 1, where lid 4 may remained joined with body 2 (e.g., like a hinge), as shown in FIGS. 1 and 2, which may make it easier for the lid to fall forward, toward the front of storage bag 1, and downward in an open position, and also remain open without support, to make it easier to access body 2 to insert or remove container 14 and/or other items, as shown in FIG. 4 (e.g., if the lid opening was instead higher at front (or hinged side) of the bag than at the rear of the bag, the lid would tend to more easily fall closed, if it not supported, making accessing the bag to insert or remove items more difficult).

With storage bag 1 detachably mounted to a vehicle, as shown mounted to exemplary pickup truck 100 in FIG. 5 and mounted to exemplary vehicle 200 in FIG. 7, lid 4 may be openable from the rear of storage bag 1 or the vehicle-facing side toward the front of storage bag 1 or the opposite side of the vehicle, where it may remain joined with body 2 (e.g., like a hinge), so that it may fold forward and downward, allowing lid 4 to drop down in front storage bag 1, as shown in FIGS. 6 and 8, without the need to be supported in an open position either by hand, by the vehicle, or by another object (e.g., since the rear of storage bag 1 may be facing a vehicle, camper, trailer, or other object to which it may be attached, opening storage bag 1 by using opening 6 may cause lid 4 to open from the rear of storage bag 1 toward the front, away from the vehicle, where it may not be blocked by the vehicle or another object from opening fully or staying opened, making access to body 2 easier).

With storage bag 1 mounted to a vehicle and lid 4 open, as shown in FIGS. 6 and 8, access to body 2 may be gained, where container 14, if present, may be either pulled out or inserted, or items may either be pulled out from container 14 or inserted into container 14. Or if container 14 is not present, items may be pulled out from body 2 or inserted into body 2. With lid 4 in an open position, as shown in FIGS. 6 and 8, access to pocket 16 may also be gained.

Storage bag 1 offers better leak protection from trash and/or liquids and/or protects stored items better; and makes loading or unloading items, including container 14, easier because it is semi-rigid and/or retains its shape. Because opening 6 is on the rear of storage bag 1 (e.g., vehicle-facing side), on the sides of storage bag 1, and partially surrounds the front of storage bag 1 (e.g., the side opposite of the vehicle-facing side); and because opening 6 is higher at the rear of storage bag 1 (e.g., vehicle-facing side) than it is at the front of storage bag 1 (e.g., side opposite the vehicle-facing side), lid 4 may open from the rear of storage bag 1 toward the front of storage bag 1, where it may remain joined with body 2, and may fold vertically or almost vertically against body 2, making loading items into or unloading items from, respectively, body 2, including container 14, easier, and may also make it easier to access pocket 16, when storage bag 1 is opened. MOLLE webbing 8, one or more of straps 10, and/or one or more of fasteners 12 may be used to secure storage bag 1 to a variety of vehicles in a variety of ways, either directly, to MOLLE-compatible accessories, or to other vehicle accessories. These features make storage bag 1 easier to use, easier to mount, and allow storage bag 1 to offer better protection for or from stored items.

What is claimed is:

1. A storage bag comprising:
a storage body configured to hold an object; and
a lid configured to open and close the storage bag to provide access to the storage body, the lid comprising:
a vehicle-facing side and an opposite side,
a lid opening section on the vehicle facing side, allowing the lid to open,
wherein the storage bag is configured to be removably attached to a vehicle or a vehicle component/accessory; and
wherein the storage bag comprises a material that retains the shape thereof.

2. The storage bag of claim 1, wherein the storage bag comprises a semi-rigid material.

3. The storage bag of claim 1, wherein the storage bag comprises a waterproof material.

4. The storage bag of claim 1, wherein the storage bag comprises molded ethyl vinyl acetate (EVA) foam.

5. The storage bag of claim 1, wherein the storage body is configured to receive a rigid insert or container.

6. The storage bag of claim 1, further comprising:
MOLLE webbing or a loop configured to be attached to a vehicle or a vehicle component/accessory;
a strap with a fastener configured to be attached to a vehicle or a vehicle component/accessory; or
a combination thereof.

7. The storage bag of claim 6, wherein the fastener is a hook and loop fastener.

8. The storage bag of claim 1, wherein the lid is configured to fold from the vehicle-facing side towards the opposite side to remain in an open position without external support.

9. The storage bag of claim 8, wherein the lid opening section on the opposite side partially surrounds the opposite side.

10. The storage bag of claim 1, wherein the lid opening section on the vehicle-facing side is positioned higher than the lid opening section on the opposite side.

11. A storage bag, comprising:
a storage body configured to hold an object; and
a lid configured to open and close the storage bag to provide access to the storage body, the lid comprising:
a vehicle-facing side and an opposite side,
a lid opening section that at least partially surrounds the opposite side and the vehicle facing side, allowing the lid to open from the vehicle-facing side towards the opposite side, and
wherein the lid opening section is configured to open from one of the vehicle facing side or the opposite side,
wherein the side that is configured to open is positioned higher than the other side such that the storage bag, when opened, remains in an open position without external support; and
wherein the storage bag comprises a semi-rigid material.

12. The storage bag of claim 11, wherein the storage bag comprises a waterproof material.

13. The storage bag of claim 11, wherein the storage bag comprises molded ethyl vinyl acetate (EVA) foam.

14. The storage bag of claim 11, wherein the storage body is configured to receive a rigid insert or container.

15. The storage bag of claim 11, wherein the lid opening section on the opposite side partially surrounds the opposite side.

16. The storage bag of claim 11, wherein the section that opens is positioned on the vehicle facing side.

17. The storage bag of claim 11, further comprising:
MOLLE webbing or a loop configured to be attached to a vehicle or a vehicle component/accessory;
a strap with a fastener configured to be attached to a vehicle or a vehicle component/accessory; or
a combination thereof.

18. A storage bag, comprising:
a storage body configured to hold an object; and
a lid configured to open and close the storage bag to provide access to the storage body, the lid comprising:
a vehicle-facing side and an opposite side,
wherein a lid opening section on the vehicle-facing side is positioned higher than a lid opening section on the opposite side, allowing the lid to open from the vehicle-facing side towards the opposite side,
wherein the lid opening section on the opposite side partially surrounds the opposite side,
wherein the lid opening section on the vehicle-facing side and the lid opening section on the opposite side are configured to be open and closed by a lid closure, and
wherein the storage bag is formed from a semi-rigid material.

19. The storage bag of claim 18, wherein the storage bag comprises a waterproof material.

20. The storage bag of claim 18, wherein the storage bag comprises molded ethyl vinyl acetate (EVA) foam.

21. The storage bag of claim 18, wherein the storage body is configured to receive a rigid insert or container.

22. The storage bag of claim 18, further comprising:
MOLLE webbing or a loop configured to be attached to a vehicle or a vehicle component/accessory;
a strap with a fastener configured to be attached to a vehicle or a vehicle component/accessory; or
a combination thereof.
